(19) United States
(12) Patent Application Publication
(10) Pub. No.: US 2002/0185005 A1
(43) Pub. Date: Dec. 12, 2002

(54) Air separation process

(76) Inventor: Shuguang Deng, Hillsborough, NJ (US)

Correspondence Address: Philip H. Von Neida, Intellectual Property Dept., The BOC Group, Inc., 100 Mountain Ave., Murray Hill, NJ, 07974, US

(21) Appl. No.: 09/841,984

(22) Filed: Apr. 25, 2001

(51) Int. Cl. B01D 53/02

(52) U.S. Cl. 95/96; 95/139

(57) ABSTRACT

The present invention discloses a pressure swing adsorption process for separating carbon dioxide and water vapor from a gas stream. By passing the gas stream through an adsorbent bed which has been subjected to a bake out process either prior to beginning the pressure swing adsorption process or intermittently during the pressure swing adsorption process, an improved separation of carbon dioxide and water vapor is achieved.

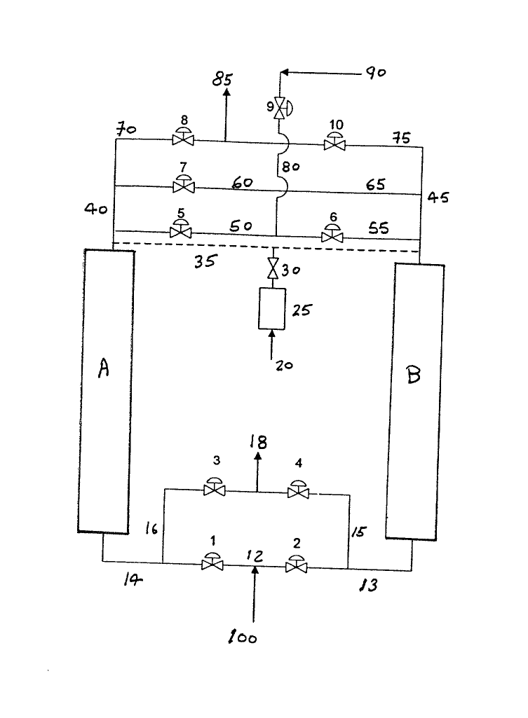

### FIELD OF THE INVENTION

The present invention relates to an improved method for separating air using a pressure swing adsorption process. More particularly, the present invention provides for an improved pressure swing adsorption process for separating carbon dioxide and water from air whereby the adsorbent bed is thermally treated prior to and intermittently during the pressure swing adsorption cycle.

### BACKGROUND OF THE INVENTION

Adsorption is well established as a unit operation for the production of pure gases, the purification of gases and their mixtures up-front, their further physical and/or chemical handling, and for the treatment of fluid waste streams. Purification and separation of atmospheric air comprises one of the main areas in which adsorption methods are widely used. For an increase of their efficiency, novel adsorbent formularies and processes of their utilization are being sought permanently.

One of the areas of strong commercial and technical interest represents pre-purification of air before its cryogenic distillation. Conventional air separation units (ASUs) for the production of nitrogen, N₂, and oxygen, O₂, and also for argon, Ar, by the cryogenic separation of air are basically comprised of two or at least three, respectively, integrated distillation columns which operate at very low temperatures. Due to these low temperatures, it is essential that water vapor, H₂O, and carbon dioxide, CO₂, is removed from the compressed air feed to an ASU. If this is not done, the low temperature sections of the ASU will freeze up making it necessary to halt production and warm the clogged sections to revaporize and remove the offending solid mass of frozen gases. This can be very costly. It is generally recognized that, in order to prevent freeze up of an ASU, the content of H₂O and CO₂ in the compressed air feed stream must be less than 0.1 ppm and 1.0 ppm or lower, respectively. Besides, other contaminants such as low-molecular-weight hydrocarbons and nitrous oxide, N₂O, may also be present in the air feed to the cryogenic temperature distillation columns, and they must as well be removed up-front the named separation process to prevent hazardous process regime.

A process and apparatus for the pre-purification of air must have the capacity to constantly meet the above levels of contamination, and hopefully exceed the related level of demand, and must do so in an efficient manner. This is particularly significant since the cost of the pre-purification is added directly to the cost of the product gases of the ASU.

Current commercial methods for the pre-purification of air include reversing heat exchangers, temperature swing adsorption, pressure swing adsorption and catalytic pre-purification techniques.

Reversing heat exchangers remove water vapor and carbon dioxide by alternately freezing and evaporating them in their passages. Such systems require a large amount, typically 50% or more, of product gas for the cleaning, i.e., regenerating of their passages. Therefore, product yield is limited to about 50% of feed. As a result of this significant disadvantage, combined with characteristic mechanical and noise problems, the use of reversing heat exchangers as a means of air pre-purification in front of ASUs has steadily declined over recent years.

In temperature swing adsorption (TSA) pre-purification of air, the impurities are removed from air at relatively low ambient temperature, typically at about (5-15)° C., and regeneration of the adsorbent is carried out at elevated temperatures, e.g., in a region of about (150-250)° C. The amount of product gas required for regeneration is typically only about (10-25)% of the product gas. Thus, a TSA process offers a considerable improvement over that of utilizing reversing heat exchangers. However, TSA processes require evaporative cooling or refrigeration units to chill the feed gas and heating units to heat the regeneration gas. They may, therefore, be disadvantageous both in terms of capital costs and energy consumption despite of being more cost-effective than the reversing heat exchangers' principle referred to above.

Pressure swing adsorption (PSA) (or pressure-vacuum swing adsorption (PVSA)) processes are an attractive alternative to TSA processes, for example, as a means of air pre-purification, since both adsorption and regeneration via desorption, are performed, as a rule, at ambient temperature. PSA processes, in general, do require substantially more regeneration gas than TSA processes. This can be disadvantageous if high recovery of cryogenically separated products is required. If a PSA air pre-purification unit is coupled to a cryogenic ASU plant, a waste stream from the cryogenic section, which is operated at a pressure close to ambient pressure, is used as purge for regenerating the adsorption beds. Feed air is passed under pressure through a layer of particles of activated alumina, to remove the bulk of H₂O and CO₂, and then through a layer of zeolite particles such as of the FAU structural type, e.g., NaX zeolite, to remove the remaining low concentrations of H₂O and CO₂. Arrangement of the adsorbent layers in this manner is noted to increase the temperature effects, i.e., temperature drops during desorption, in the PSA beds. In other configurations, only activated alumina is used to remove both H₂O and CO₂ from feed air. This arrangement is claimed to reduce the temperature effects.

It will be appreciated that, although many pre-purification methodologies based on PSA have been proposed in the literature, a few of those are actually being used commercially due to high capital costs associated therewith.

In general, known PSA pre-purification processes require a minimum of 25%, typically (40-50)%, of the feed as purge gas. As a result of having low adsorbent specific product, such processes have high capital cost. Reduction in capital costs of air pre-purification systems is particularly important when a large plant is contemplated. Therefore, it will be readily appreciated that, for large plants, improvements in pre-purification system operation can result into considerable cost savings.

However, past PSA processes have not been able to remove carbon dioxide to less than one part per million. The only means to achieve this lower level using standard PSA processes is to increase the size of the adsorbent beds. However, due to the short cycle times of PSA PPU processes, larger adsorbent beds result in higher vent loses and consequently poor plant economy performance. The present inventor has discovered that by heating the adsorbent bed prior to the start of the PSA PPU cycle or intermittently throughout the cycle will improve the removal of carbon dioxide and achieve levels approaching one part per billion prior to the introduction of the air into a cryogenic distillation unit.

### SUMMARY OF THE INVENTION

The present invention provides for an improved pressure swing adsorption process for removing carbon dioxide and water from a feed gas using an adsorbent bed comprising a mixture of alumina and a zeolite and/or an activated carbon. The improvement comprises heating the adsorbent bed prior to or intermittently during the PSA by heating the adsorbent bed to a temperature 50 to 750° C. under the flow of a dry inert gas stream. CO₂ levels can be lowered to levels below one part per million without resorting to larger bed sizes nor long periods to achieve a steady state cycle. As such, the present invention not only achieves a lower carbon dioxide in the product air being sent to the cryogenic distillation unit but will also provide for an improved PSA PPU process whereby steady stages achieved quicker while requiring smaller adsorption vessels thereby lowering vent loss and pressure drops during the feed and purge steps. This will provide for a more economical pressure swing adsorption process.

### BRIEF DESCRIPTION OF THE DRAWING

The FIGURE is a schematic diagram of a pressure swing adsorption pre-purification unit showing the inventive adsorbent bake out.

### DETAILED DESCRIPTION OF THE INVENTION

The present invention provides for a pressure swing adsorption process for removing carbon dioxide and water vapor from a feed gas comprising sequentially introducing the feed gas at elevated pressure into a first adsorbent bed thereby separating the carbon dioxide and water vapor from the feed gas, then depressurizing and purging the bed with effluent from the bed or a carbon dioxide free dry gas stream. The improvement in the PSA PPU process is the bake out of the adsorbent bed prior to or intermittently during the PSA cycle. The adsorbent bed will contain a mixture of an alumina and a zeolite and/or an activated carbon.

In an alternative embodiment, the present invention provides for a pressure swing adsorption process for removing carbon dioxide and water vapor from a feed gas comprising sequentially (a) introducing into a first adsorption bed a feed gas at elevated pressure, (b) depressurizing the first adsorption bed while beginning feed to a second adsorption bed, (c) purging the first adsorption bed while continuing feed to the second adsorption bed, (d) pressurizing the first adsorption bed while continuing feed to the second adsorption bed whereby the first adsorption bed is baked out either prior to the pressure swing adsorption process cycle beginning or intermittently during the cycle.

Preferably, this is a two bed PSA PPU process, however, anywhere from two beds up to eight beds can be employed successfully. The adsorbent materials employed in the adsorbent beds will comprise activated alumina typically used to remove water and an X type zeolite such as 13X zeolite which may be used to remove the carbon dioxide. Typically, the X type zeolite is a sodium X zeolite with a silicon to aluminum elemental ratio of the zeolitic phase between 0.9 and 1.3, preferably 0.9 and 1.15 and most preferably between 0.95 and 1.08. The ratio of activated alumina to zeolite in the adsorbent bed may range from about 10% to 90%.

In an alternative embodiment, activated carbon may be employed in place of the X zeolite or a mixture comprising zeolite and activated carbon in ratios of about 10% to about 90% by weight zeolite can be employed in the adsorbent bed. The adsorbent beds are baked out using any type heater which is commercially available and known to those skilled in the art. The bake out will occur at temperatures-ranging from about 50 to about 750° C. whereby an inert gas stream which can be nitrogen, air, helium or other gas mixture of inert gases is passed through the bed at the desired elevated temperature. This bake out of the adsorbent bed will counteract the formation of strong carbon dioxide adsorption sites on the alumina surface which typically causes the problem of achieving levels of CO₂ concentration below 1 ppm. This bake out accomplishes this CO₂ removal without the need of larger adsorption beds nor would the resultant vent losses that large adsorption beds encumber. The feed gas steam is typically atmospheric air which is treated prior to being introduced into a cryogenic distillation unit. The pressure swing adsorption pre-purification unit is designed to remove water, carbon dioxide and other trace impurities in the atmospheric air prior to this introduction into the distillation unit.

The improved PSA PPU process of the present invention is shown schematically in the FIGURE. Each bed will cycle through the steps of feed with gas stream, blow down from high to ambient pressures, purged with waste gas and re-pressurization from ambient to higher feed pressure. The adsorption step of the present invention can be carried out in any of the usual and well-known pressures employed for gas phase pressure swing adsorption processes. This pressure envelope may vary, but it is dependent upon the pressure at which adsorption takes place as well as the pressure at which desorption of the gas occurs. Typically, this ranges about 20 bara in the adsorption step to about 0.05 bara in the purge step with the range of about 10 bara to about 0.15 bara preferred, and a range of about 6 bara to about 1 bara most preferred. The temperature at which the process is carried out will typically range from about 5° C. to about 35° C. for the adsorption step. However, temperatures as high as 200° C. can be employed.

With reference now to the FIGURE, a two bed pressure swing adsorption pre-purification process is shown. Two beds A and B are employed in this process. The cycle begins with feed of a gas stream, typically air, at high pressure to bed A through line 100 to line 12, through open valve 1, through line 14. The feed continues in bed A. Bed B is depressurized through line 13 to line 15, through open valve 14, through the vent 18. As feed continues in bed A, purge begins in bed B whereby valve 6 is opened allowing for purged gas to travel through bed B as feed continues to bed A, valves 1 and 8. Valve 6, however, is closed and valve 7 open allowing for pressurization to begin in bed B, through line 60 to line 45. As pressurization finishes in bed B, bed A begins depressurization in the next step. Valve 2 is opened allowing input gas to travel along line 13 into bed B. Valve 3 is opened allowing blow down through line 14 to line 16, through open valve 3, through the vent 18 to occur from bed A. Valve 9 is also opened allowing nitrogen through nitrogen inlet 90 to enter through line 80 wherein the next step of the cycle bed A is purged as valve 5 is open allowing nitrogen to travel along line 40 into the top of bed A. Simultaneously, valve 2 remains open allowing inlet gas to be fed into bed B while valve 3 remains open allowing venting of the purged waste gas from bed A to the atmosphere.

As shown in the FIGURE, line 20 is the input for the inert gas to the heater 25. This heated gas will then travel through valve 30 to line 35 which connects both to line 40 and lines 45 entering beds A and B, respectively. During a typical cycle, the heater will be activated and will be able to provide the heated inert gas to either beds A or B. During the cycle itself, during the depressurization steps of the PSA cycle, valve 30 may be opened up and allow hot air to enter either of the beds which is undergoing depressurization. This step improves the efficiency of the overall cycle and makes the overall PSA PPU process more robust and vigorous.

Table 1 demonstrates a typical PSA PPU cycle and sequence of valves open as well as their timing. The following examples are demonstrations of the present invention and should not be construed as limiting thereof.

TABLE 1
Typical PSA PPU Cycle and Sequence of Valves Opening

| Steps | | Valves | Duration-1 | Duration-2 |
|---|---|---|---|---|
| Bed A | Bed B | Open | (seconds) | (seconds) |
| Pressurization | Feed | 2, 7, 9 | 360 | 150 |
| Feed | Depressurization | 1, 4, 8 | 90 | 30 |
| Feed | Purge | 1, 4, 6, 8 | 510 | 540 |
| Feed | Pressurization | 1, 7, 8 | 360 | 150 |
| Depressurization | Feed | 2, 3, 9 | 90 | 30 |
| Purge | Feed | 2, 3, 5, 9 | 510 | 540 |

### EXAMPLE 1

Experiments were carried out in a PSA PPU unit containing two identical 5.24 inch inside diameter beds having a bed height of 86.5 inches. The bed was packed with four inches of ceramic balls at the bottom and 82.5 inches of Alcoa H-156 7×14 tyler mesh. The Alcoa H-156 is a composite adsorbent containing about 60% activated alumina and about 40% of zeolite 4A. This is commercially available zeolite composite adsorbent.

The pressure swing adsorption experiments were run with the feed air containing 350 to 400 ppm carbon dioxide at 77.5 psia and 25° C. The regeneration was performed with carbon dioxide free dry nitrogen. The purge to feed ratio (P/F) defined by the following equation was about 2.2. P/F=(F_{purge}×t_{purge}×P_{feed})/(F_{feed}×t_{feed}×P_{purge}) wherein F_{feed} equals the feed flow rate and standard cubic feet per minute, F_{purge} equals the purge flow rate and standard cubic feet per minute, t_{feed} equals the feed duration in seconds, t_{purge} equals the purge duration in seconds, P_{feed} equals the feed pressure at bottom of bed in pounds per square inch atmospheric, P_{purge} equals purge pressure at bottom of bed in pounds per square inch atmospheric.

The cycle time listed in Table 1 Duration-1 was employed. It took more than two weeks to remove carbon dioxide from air down to less than 3 ppb carbon dioxide. CO₂ concentration profiles inside the H-156 bed were measured after CO₂ concentration and product had reached 3 ppb. The adsorbent specific products for different CO₂ concentrations in product were determined from these CO₂ concentration profiles. The adsorbent specific products are adsorbent specific product for 1 ppm CO₂ in product equals 11.5 standard cubic foot/pound of H-156. Adsorbent specific product for 3 ppb CO₂ in product equals 4.9 standard cubic foot/pound of H-156. The adsorbent specific product for 1 ppm CO₂ in product is about 2.3 times the adsorbent specific product for 3 ppb CO₂ in the product. This result clearly demonstrates that activated alumina adsorbent mixture is effective to remove CO₂ and air down to 1 ppm. The very inefficient after 1 ppm CO₂ in air once the alumina based adsorbent mixture adsorbs a low level of moisture.

### EXAMPLE 2

The two H-156 adsorbent beds used in Example 1 were thermally treated simultaneously at 100° C. and under a nitrogen flow for about 20 hours and cooled under the same nitrogen stream for four hours. The nitrogen flow rate for both bed A and bed B was 15 scfm. PSA PPU cyclic experiments were carried out on the thermally treated H-156 bed at similar experimental conditions to those used in Example 1. Cycle times used are listed as Duration-2 from Table 1. The purge to feed ratio in this run was 2.6. CO₂ was very efficiently removed from about 400 ppm in the feed to less than 1 ppb in the product. The adsorbent specific product for 3 ppb CO₂ in product increased from 4.9 in untreated H-156 bed to 11.5 scsf/pound of H-156 in the thermally treated H-156 bed. This clearly demonstrates that the thermally treated H-156 has a much better performance, nearly twice than that of the untreated H-156.

While this invention has been described in conjunction with the specific embodiment described above, it is evident that many variations, alterations and modifications will be apparent to those skilled in the art in light of the foregoing description. Accordingly, it is intended to embrace all such alterations, modifications and variations that fall within the scope and spirit of the appended claims.

Having thus described the invention, what I claim is:

1. A pressure swing adsorption process for removing carbon dioxide and water vapor from a feed gas comprising
introducing said feed gas into an adsorption bed containing an adsorbent whereby said adsorbent has undergone thermal bake out;
depressurizing said adsorbent bed; and
purging said adsorbent bed with the gaseous effluent from said bed or with another gas that is substantially free of carbon dioxide thereby desorbing carbon dioxide from said bed.

2. The process as claimed in claim 1 wherein from 2 to 8 beds are present.

3. The process as claimed in claim 1 wherein said feed gas is air.

4. The process as claimed in claim 1 wherein said purified feed gas is fed to a cryogenic distillation unit.

5. The process as claimed in claim 1 wherein said adsorbent bed comprises an adsorbent mixture comprising activated alumina and zeolite.

6. The process as claimed in claim 5 wherein said zeolite is X type zeolite.

7. The process as claimed in claim 6 wherein said X type zeolite is sodium X zeolite with a silicon to alumina elemental ratio between 0.9 and 1.3.

8. The process as claimed in claim 1 wherein said bake out temperature ranges between 50° and 750° C.

9. The process as claimed in claim 8 wherein said bake out temperature is about 150° C.

10. The process as claimed in claim 1 wherein said bake out occurs with inert gas passing through said adsorbent bed.

11. The process as claimed in claim 10 wherein said inert gas is selected from the group consisting of air, nitrogen, helium and mixtures thereof.

12. The process as claimed in claim 1 wherein said bake out is performed either prior to said pressure swing adsorption process or intermittently during the pressure swing adsorption process.

13. A pressure swing adsorption process for removing carbon dioxide and water vapor from a feed gas comprising:
(a) passing said gas mixture through at least one adsorption zone wherein said adsorption zone has been treated by a bake out process at a selected temperature and a selected pressure thereby preferentially adsorbing carbon dioxide and water from said gas mixture; and
(b) regenerating said adsorbent at a temperature higher than said selected temperature and at a pressure lower than said selected pressure.

14. The process as claimed in claim 13 wherein said feed gas is air.

15. The process as claimed in claim 13 wherein said bake out temperature ranges between 50° and 750° C.

16. The process as claimed in claim 15 wherein said bake out temperature is about 150° C.

17. The process as claimed in claim 13 wherein said bake out occurs with inert gas passing through said adsorbent bed.

18. The process as claimed in claim 17 wherein said inert gas is selected from the group consisting of air, nitrogen, helium and mixtures thereof.

19. The process as claimed in claim 18 wherein said bake out is performed either prior to said pressure swing adsorption process or intermittently during the pressure swing adsorption process.
